(19) United States
(12) Patent Application Publication
(10) Pub. No.: US 2014/0192407 A1
(43) Pub. Date: Jul. 10, 2014

(54) Method and Apparatus for Shaping Dynamic Light Beams to Produce 3D Perception in a Transmitted Light Microscope

(71) Applicant: Edge-3D, LLC, Paia, HI (US)

(72) Inventor: Gary Greenberg, Paia, HI (US)

(73) Assignee: Edge-3D, LLC, Paia, HI (US)

(21) Appl. No.: 14/150,003

(22) Filed: Jan. 8, 2014

Related U.S. Application Data
(60) Provisional application No. 61/751,034, filed on Jan. 10, 2013.

(51) Int. Cl. G02B 21/08; G02B 21/06

(52) U.S. Cl. CPC G02B 21/086; G02B 21/06
USPC 359/385

(57) ABSTRACT

An illuminator for a transmitted light microscope for producing stereo viewing as well as motion parallax 3D perception, using a generally pyramid-shaped mirror having a plurality of facets and light source adjacent a plurality of the facets and a computer-driven electronic circuit for controlling the on/off status of said light sources.

### FIELD OF THE INVENTION

The present invention relates to a transmitted light microscope illuminator and, more specifically, to methods and apparatus by which an illuminator for an otherwise 2D transmitted light microscope enhances the microscope's capabilities to include stereo 3D and motion parallax 3D perception.

### BACKGROUND OF THE RELATED ART

In my U.S. Pat. No. 6,891,671, I teach that by physically obscuring successive portions of the aperture of a light microscope, stereo 3D and motion parallax 3D perception can be achieved. The present invention is an improved 3D imaging system that employs a unique illumination system (illuminator) that produces and deploys a shaped light beam to create motion parallax.

### SUMMARY OF THE INVENTION

The novel lighting system and methods of the present invention produces shaped light beams controlled by a computer having a functional graphical user interface (GUI). There are a number of advantages to the present invention over the prior art. The present invention is by far the least complex and least expensive way of producing 3D images in a transmitted light microscope. Other systems require mechanical moving parts, special lenses, prisms and apertures that are expensive and difficult to implement and require that parts of the microscope be rebuilt. The same problems occur with systems that use LCD shutters or moving mechanical aperture elements. In the present invention, a multi-element lighting unit replaces the traditional microscope illumination bulb, whereby the present invention is easily adapted to upgrade a standard 2D microscope to produce stereo 3D and motion parallax 3D perception.

Another advantage of the present invention over the prior art is that it does not sacrifice light intensity by blocking any portion of the aperture, as do prior art LCD shutter systems. In addition, LCD shutters polarize the light, and polarized light is not compatible with some optical modalities, such as polarization microscopy or Nomarski optics. The illumination system of the present invention is compatible with all such systems, since no light polarization takes place in order to produce 3D images.

The light source has a strategic position in the optical path of a light microscope because it can be made optically conjugate to the pupil (or aperture) of the objective lens, known as Koehler illumination. The novel illuminator of the present invention comprises an array of individual light sources (lighting elements) that are positioned to replace a standard bulb in a light microscope. In this position, each small lighting element illuminates only a portion of the aperture of the optical system. Each lighting element can be individually controlled to be either turned on or off, have a selected lumen output (intensity), and turned on for a selected duration. This arrangement allows a user to control the individual light sources, thereby producing shaped light beams that fill only selected portions of the microscope's objective aperture.

A computer is programmed to control an electronic circuit that enables individual light sources to be on or off so as to produce a light beam having one of a plurality of different shapes (configurations). These shapes or configurations, selected by the computer program, can be changed very rapidly, and thus made to appear to move, for example, in a rotational manner, thus producing moving motion parallax from which 3D images can be seen in real-time and without the need for 3D glasses.

The novel, dynamic, computer-driven illuminator of the present invention is an inexpensive solution for producing three-dimensional images in light microscopes. The present invention does not require extra lenses or mechanical moving parts, or aperture masks, or expensive LCD shutters, as with the prior art. The present invention simply replaces the bulb of a conventional 2D light microscope with the novel computer-controlled illuminator, converting the 2D microscope into a 3D microscope that produces both stereo 3D images and motion parallax 3D images in real-time.

### DESCRIPTION OF THE DRAWINGS

FIG. 1 is a schematic plan view of a prior art microscope condenser lens aperture fully illuminated;

FIG. 1a is a schematic side view of the prior art condenser lens having the aperture of FIG. 1;

FIG. 2 is a schematic plan view of a prior art microscope condenser lens aperture illuminated by a shaped beam illustrating that less than all of the aperture is illuminated;

FIG. 2a is a schematic side view of the prior art condenser lens having the aperture of FIG. 2;

FIG. 3 is another schematic plan view of a prior art microscope condenser lens aperture illuminated by a shaped beam illustrating that less than all of the aperture is illuminated;

FIG. 3a is a schematic view of the prior art condenser lens having the aperture of FIG. 3;

FIG. 4 is a schematic plan view of a prior art microscope condenser lens aperture illuminated by another shaped beam illustrating that less than all of the aperture is illuminated;

FIG. 4a is a schematic side view of the prior art condenser lens having the aperture of FIG. 4;

FIG. 5 is a schematic plan view of a condenser lens aperture illuminated by a shaped beam that is made to appear to rotate;

FIG. 6A is a schematic diagram of a prior art transmitted light microscope in conjunction with a digital camera (still or video) and a display monitor;

FIG. 6B is a schematic diagram of a prior art transmitted light microscope having a conventional eyepiece for real time viewing;

FIG. 7A is a schematic diagram showing a plan view of the illuminator of the invention;

FIG. 7B is a schematic diagram showing a side elevation view of the illuminator of the invention;

FIG. 8 is a schematic view of a transmitted light microscope having the illuminator of the invention in place of a light bulb and a computer-driven driver circuit;

FIG. 9A is a schematic plan view of the illuminator of the invention configured to provide standard 2D viewing;

FIG. 9B is a schematic plan view of the illuminator of the invention configured to provide one view of a stereo pair of photographs for 3D viewing;

FIG. 9C is a schematic plan view of the illuminator of the invention configured to provide the second view of a stereo pair of photographs with the configuration of FIG. 9B for 3D viewing;

FIG. 10A is a schematic plan view of the illuminator of the invention configured to provide oblique illumination of a high degree;

FIG. 10B is a schematic plan view of the illuminator of the invention configured to provide oblique illumination of a moderate degree;

FIG. 10C is a schematic plan view of the illuminator of the invention configured to provide oblique illumination of a low degree;

FIGS. 11A-11I are a series of schematic plan views of the illuminator of the invention configured to progressively change the orientation of a shaped beam so as to produce a rotating 3D viewing;

FIGS. 12a-12f are a series of schematic plan views of the illuminator of the invention configured to produce a rotating 3D view employing a smoothing configuration; and

FIG. 13 is a schematic view of a computer GUI for controlling the illuminator of the invention.

### DETAILED DESCRIPTION OF THE INVENTION

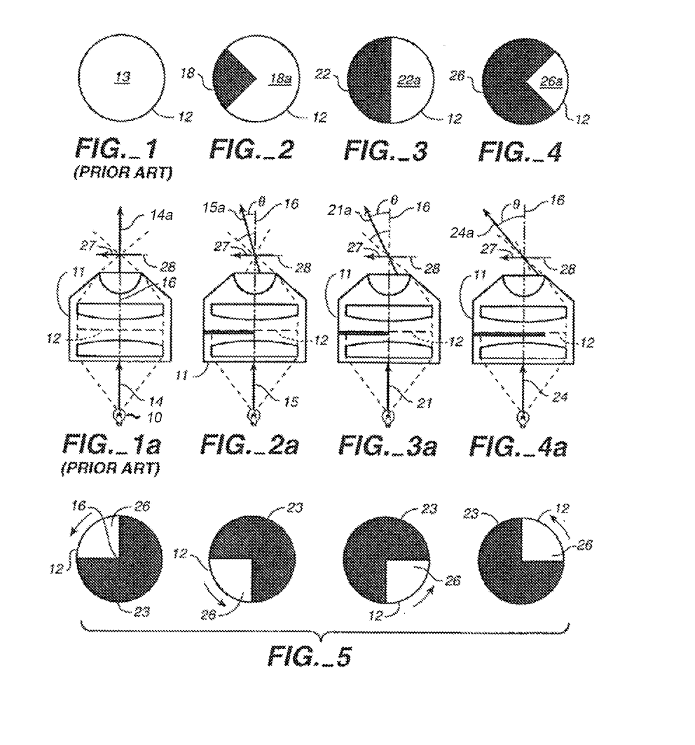

Referring to FIGS. 1 and 1a (Prior Art), a typical prior art transmitted light microscope (not all parts of which are shown) has a condenser lens 11 with an aperture 12 (shown in plan view in FIG. 1) having an area 13. The microscope illumination is provided by a light bulb 10 which, when emitting light, provides a light beam 14 along the microscope's optical axis 16 that enters the condenser lens 11 passing through its aperture 12 and exiting along an optical axis 14a that, in this case, coincides with the microscope's optical axis 16. There being no non-concentric shaping of the beam 14, the entire area 13 of aperture 12 is typically filled with the light from beam 14, as indicated by the area 13 being all white (unless otherwise indicated, white connotes an area that is illuminated and black connotes an area that is not illuminated or “dark”).

As more fully described below, in reference to the present invention, a light beam is considered “shaped” when it non-concentrically illuminates less than the entire area 13 of the condenser lens aperture 12. In other words, the shaping of the light beam in the present invention is not the standard concentric shaping such as produced by a conventional iris diaphragm, an annulus, or a dark field aperture. By being non-concentric, the beam can be rotated to produce a changing effect.

Referring to FIGS. 2 and 2a, a light beam 15 is non-concentrically shaped such that it leaves a portion of the aperture 12 (sector 18) dark while illuminating the remainder of the aperture (sector 18a). In this example, the light beam 15 fills only three-quarters of the lens aperture 12 (sector 18a) and thus its optical axis 15a as it exits from the lens 11 is at an angle Ø relative to the optical axis 16. The angle Ø is a measure of the obliquity of the exit beam 15a which is a function of the non-concentric area 13 of the aperture 12 that is illuminated.

FIGS. 3 and 4 illustrate different non-concentrically shaped beams creating different sector illumination patterns having exit beams with different angles Ø of obliquity. Referring to FIG. 3, a shaped beam 21 illuminates only a sector 22a of the aperture 12 while the remaining sector 22 is dark, producing an exit light beam 21a having an optical axis with a more extreme oblique angle Ø than exit beam 15a (FIG. 2).

Referring to FIG. 4, a shaped beam 24 illuminates only a sector 26a (one quarter of aperture 12) while the remaining sector 26 is dark, producing an exit light beam 24a having an optical axis with an even more extreme oblique angle Ø than beam 21a. The angle of obliquity is inversely proportional to the non-concentric, off-center area of aperture 12 that is illuminated—the more off-center the area of illumination, the greater the angle of obliquity of the exit beam and vice versa.

Thus, for each of the embodiments of FIGS. 2a-4a, an object 27 at an image (focal) plane 28 is illuminated with oblique illumination and ultimately viewed from an angle Ø relative to the microscope optical axis 16.

A photograph of object 27 (specimen), for example, illuminated with shaped beam 21 (FIG. 3) and then with a beam in which the illuminated and dark sides are exchanged in a left-right manner, produces a stereo 3D pair of photographs, allowing an observer (not shown) to view the object from two angles simultaneously—a left-eye angle and a right-eye angle—and thus in apparent 3D.

Referring to FIG. 5, by effectively rotating a shaped beam, such as beam 24 (FIG. 4), about an axis normal to the lens aperture 12 and through its center, the portion 26 of the lens aperture 12 that is illuminated (and passes light) is continually changed (rotated) such that the view of the image of object 27 will be from a continually changing angle, allowing the observer to interrogate the object through 360 degrees. By way of contrast, stereo 3D viewing only allows the observer to view the object from two angles—a left-eye angle and a right-eye angle as described above.

As used herein, the term “dynamic shaped beam” shall be understood to mean a beam that non-concentrically fills less than the entire objective aperture 12 and which is continuously rotated within the objective aperture 12, as described above in connection with FIG. 5. When an object is illuminated with a dynamic shaped beam (rotating oblique illumination), the image of the object will be enhanced in a manner fully disclosed and taught in Greenberg U.S. Pat. No. 5,345,333.

The present invention resides in an illuminator that produces a shaped light beam and a dynamic shaped beam to produce the results described above.

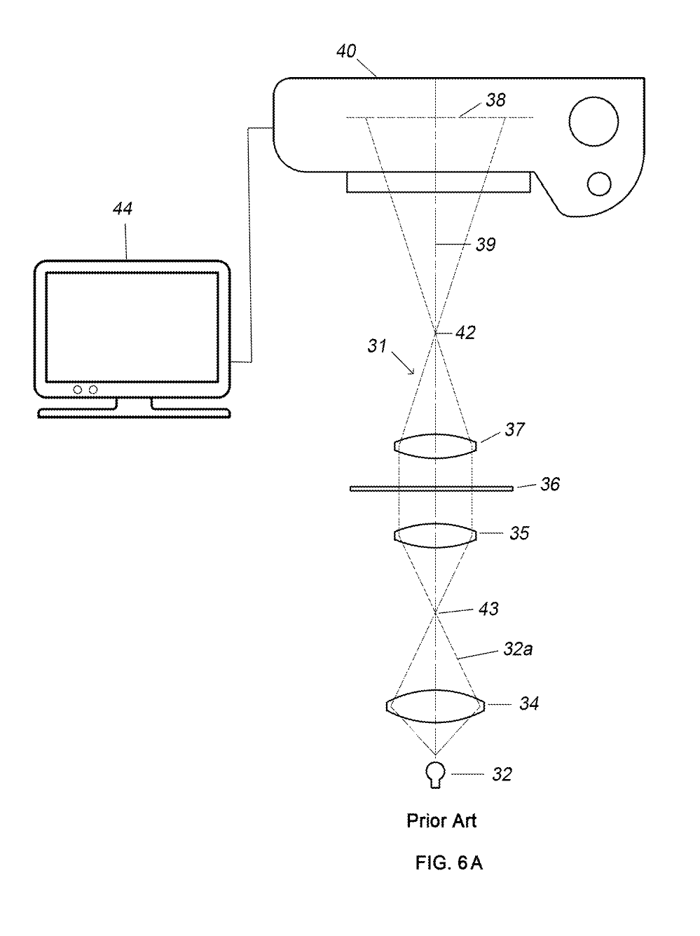

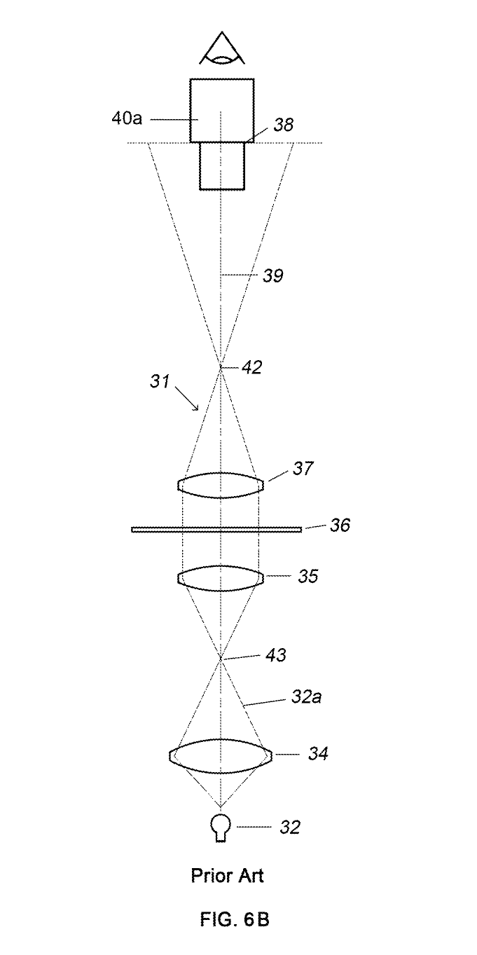

Referring to FIG. 6A, the basic elements of a standard prior art 2D transmitted light microscope 31 include a standard illuminator (light bulb) 32, a collector lens 34, a condenser lens 35, a specimen plane 36, an objective lens 37 and an image plane 38 (illustrated in a camera 40), all disposed along the optical axis 39 in a manner well known to those skilled in the art. The camera 40 is typically a digital camera capable of both still photography and video photography with a viewable output on a monitor 44 as is well known in the art.

The illuminator 32 is disposed in a location on the microscope optical axis where it is imaged in the back focal plane 42 of the objective lens 37 (commonly known as Koehler illumination). The back focal plane (or aperture) 42 of the objective lens 37 is optically conjugate to the aperture 43 of the condenser lens 35, as well as the light bulb 32. The focused beam 32a from collector lens 34 fills the aperture 43 of the condenser lens 35 and the objective aperture 42 of objective lens 37 (see FIG. 1).

FIG. 6B illustrates a prior art microscope that is substantially identical with that of FIG. 6A, except an eyepiece 40a replaces the camera 40 and monitor 44.

In the present invention, the bulb 32 is replaced with the novel lighting system (illuminator) of the present invention that enhances the microscope's capabilities to include stereo 3D and motion parallax 3D perception as fully described below.

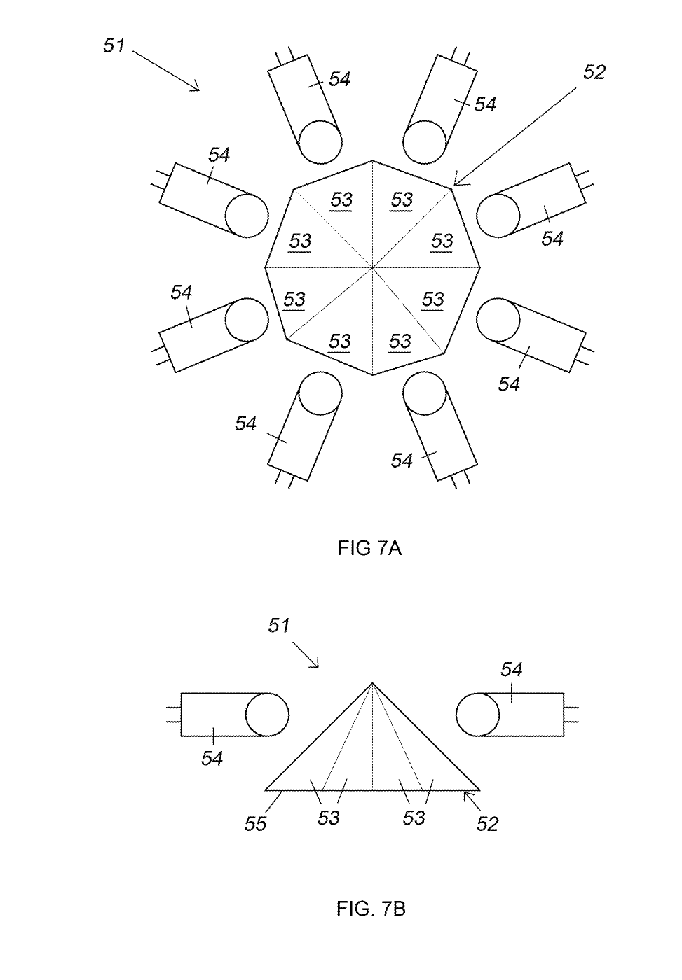

Referring to FIGS. 7A and 7B, the central component of an illuminator 51, according to the present invention, is a generally pyramid-shaped mirror 52 having a plurality of generally triangular adjacent mirror facets 53 and a base 55 that can be quadrilateral or any polygon shape. While the pyramid-shaped mirror 52 is shown with eight facets 53 for purposes of illustrating the invention, the invention is not so limited, as the illuminator 51 is fully functional with a mirror 52 having as few as four facets 53 and as many as sixteen or more, as well as any number there between.

A light source 54—such as a light emitting diode (LED)—is disposed adjacent to a plurality of mirror facets 53. While in a preferred embodiment there is a light source 54 adjacent each facet 53 (as shown), it is within the scope of the invention for there to be fewer light sources 54 than facets 53. Each light source 54, when turned on (emitting light), illuminates its adjacent mirror facet 53. While LEDs are preferred as light sources, other lighting devices that can be turned on and off, have their lumen output varied as well as the duration of output varied, all in response to electrical signals, are within the scope of the invention. Each light 54, when turned on, illuminates its adjacent mirror facet 53 which directs the light into the condenser lens 34 (FIG. 6A).

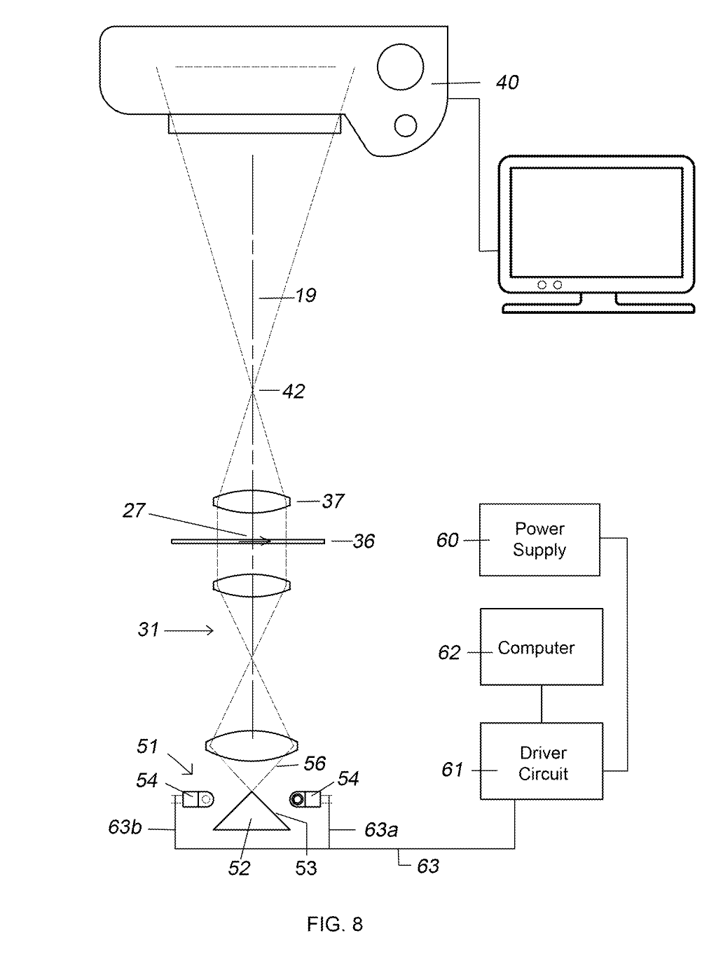

Referring to FIGS. 7A, 7B and 8, the mirror 52 having eight facets 53 is disposed at a location in the microscope optical system (where light bulb 12 was located) where its plan view (FIG. 7A) is imaged in the back focal plane 42 of the objective lens 37 (commonly known as Koehler illumination). In a preferred embodiment, each light source 54 is disposed about the pyramid mirror 52 at a location adjacent to a single facet 53 which it can illuminate and, thus, in the case of eight mirror facets 53, a one-eighth pie-shaped sector of the objective aperture 42. In the case of four mirror facets 53 (or eight mirror facets with two adjacent light sources turned on), for example, a one-quarter pie-shaped sector of the objective aperture 42 will be illuminated as illustrated in FIG. 4. It follows that turning on only one light 54, and thus illuminating only one mirror 53, illuminates one-eighth of the objective aperture 42, etc. When all of the lights 54 are turned on, the entire area of the aperture 42 is illuminated (FIG. 1). When less than all of the eight mirror facets 53 are illuminated (less than all of the lights 54 are turned on), the beam 56 will be “shaped”, meaning that less than the entire area of the aperture 22 is illuminated non-concentrically and the shaped beam 56 will illuminate a specimen 27 at specimen plane 36 at an oblique angle, as fully explained above in connection with FIGS. 1-4.

In a preferred embodiment, the mirrors 53 are equal in size and shape and each constitutes an equal part of the area of the pyramid mirror projected onto a plane perpendicular to the optical axis 19 of the microscope 31 (plan view) as best seen in FIG. 7A.

Referring to FIG. 8, a power supply 60 provides the energy necessary to turn on light sources 54 and a driver circuit 61 determines which light sources 54 are connected to and receive energy from power supply 60 to turn them on, and at what lumen output and for how long. A computer 62 is operatively disposed with respect to the driver circuit 61 and programmed to cause the electronic circuit 61 to turn light sources 54 on and off according to a predetermined sequence. In a manner well known to those skilled in the art, driver circuit 61 is designed to independently connect each light 54 with power source 60 whereby any light 54 or combination of lights 54 can be turned on or off, have its lumen output varied and its lumen output timed. Software executed by computer 62 instructs the driver circuit 61, disposed between the power supply and the light sources 54, to execute various sequences that cause the lights 54 to be turned on and off in a manner that produces 3D perception, as well as standard 2D viewing, as more fully described below.

The examples below are all with reference to a mirror 52 having eight facets 53. The invention is not so limited by the number of facets, as a mirror having more or less than eight facets is well within the scope of the invention. However, the best results are achieved with a mirror 52 having four or more facets 53.

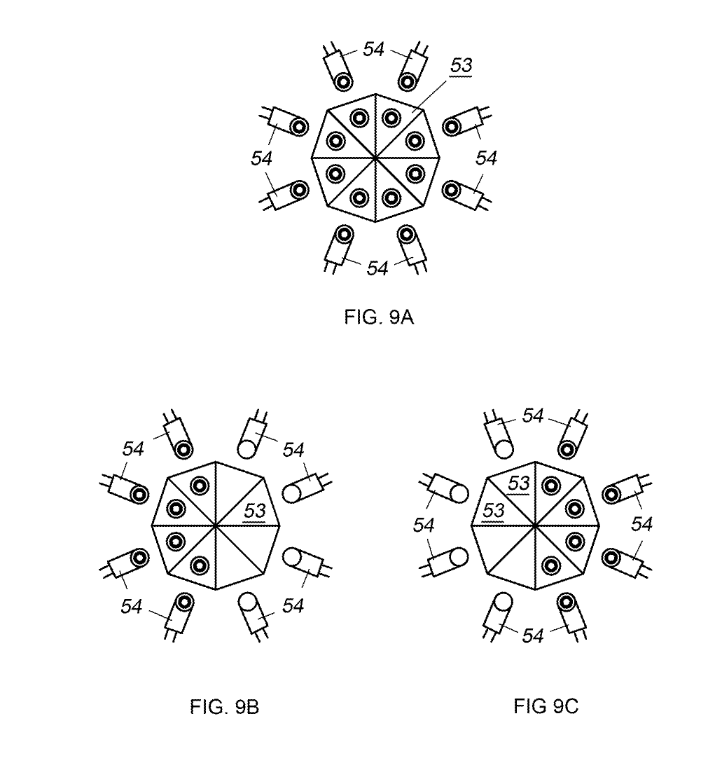

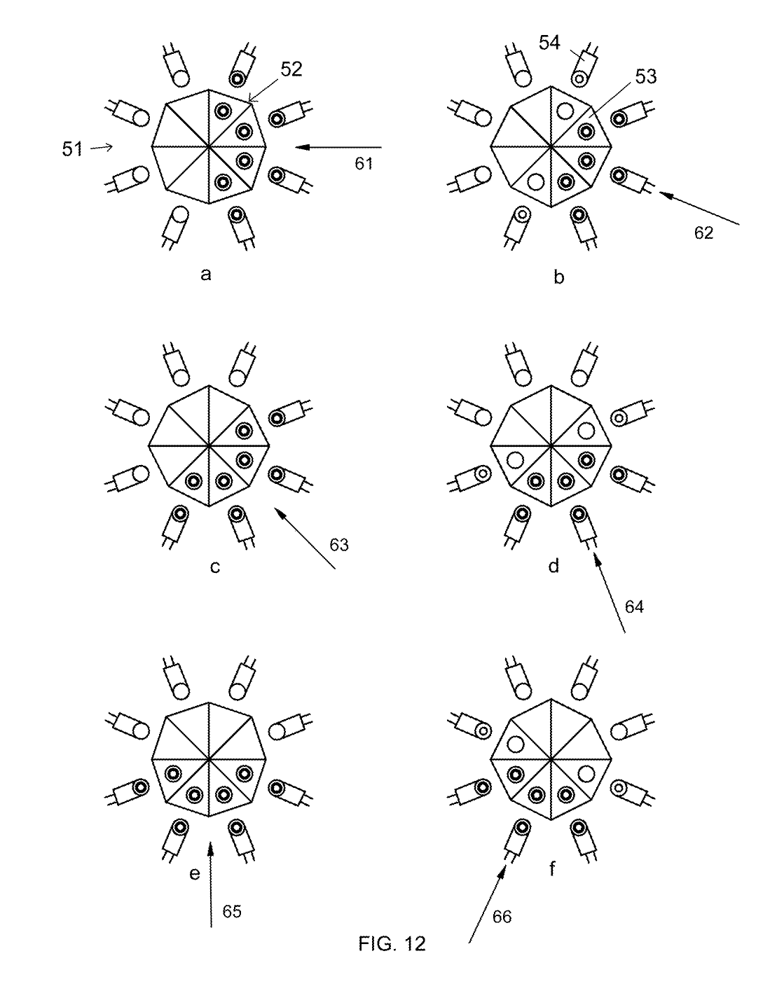

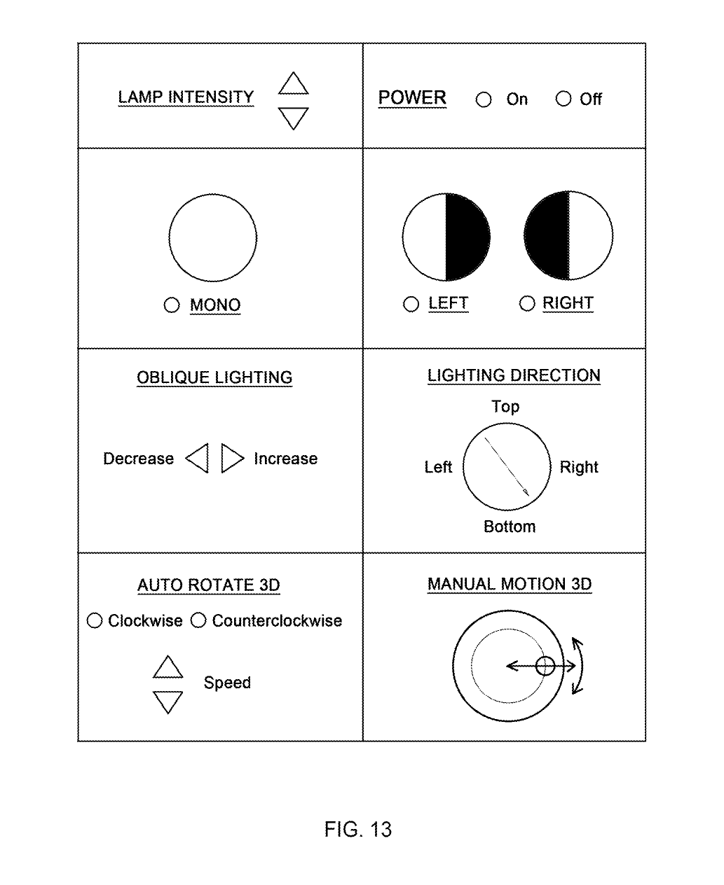

The schematic illustrations of FIGS. 9A-C, 10A-C and 12a-f employ symbols that are to be understood as follows: a concentric circle-symbol on a light 54 indicates that the light is turned on and each mirror 53 that has a concentric circles symbol indicates that it is illuminated by its corresponding light source 54 (e.g., FIG. 9A). Each mirror facet 53 that is blank (containing no symbol) is “dark” with its corresponding light 54 indicated as turned off by a single circle symbol (e.g., FIG. 9B). A mirror facet 53 containing a single circle symbol represents a facet whose corresponding light 54 is turned on, but at some reduced lumen output whereby that facet is illuminated at some diminished brightness (e.g., FIGS. 12b, d, and f).

Referring to FIGS. 9A-C, when all of the lights 54 are turned on (FIG. 9A), each facet 53 is illuminated whereby the entire area of the objective aperture 42 (FIG. 6) is illuminated, providing standard 2D microscope viewing as illustrated in FIG. 1. Various patterns created by less than all of lights 54 being turned on can produce stereo viewing. For example, FIGS. 9B and 9C create matched shaped beams for stereo viewing. A beam shaped by half (four) of the lights 54 turned on while the remaining (four) lights are off, produces a left-eye oblique view (FIG. 9B). FIG. 9C illustrates a beam also shaped by half (four) of the lights 54 turned on while the remaining lights are off. The lights that are off in the configuration of FIG. 9B are turned on in FIG. 9C and those that are turned on in FIG. 9B are turned off in FIG. 9C.

The above-described lighting patterns create a left-eye view of the object 27 (FIG. 8) and a right-eye view. These two images viewed together constitute a 3D stereo pair image that can be seen in 3D using any one of a number of well-known 3D viewing methods/devices. While the example above includes half of lights 54 being illuminated and half dark, a stereo pair can be created using more or less than half of the lights 54. For best results with a mirror 52 having eight facets 53, the stereo pair should be formed by six or less light sources turned on.

Thus, to create a stereo pair, a photograph is taken with a specimen illuminated by a first illumination configuration of a first set of less than all of the light sources 54 turned on while the remaining light sources 54 are off, and then a second photograph is taken with the specimen illuminated by a second illumination configuration of a second set of the same number of light sources 54 turned on while the remaining light sources 54 are off, wherein each light source 54 turned on in the second set is at positions approximately 180 degrees from a light source turned on in the first set.

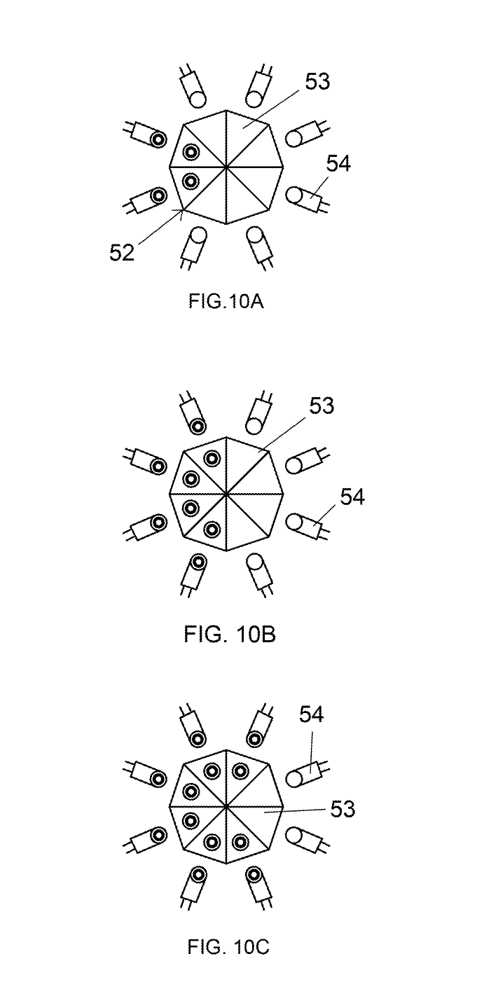

FIGS. 10A, B, and C illustrate how the invention is able to produce views of the specimen from parallax angles of varying degrees. Parallax angle is illustrated and described above in connection with FIGS. 2-4. The lighting configuration shown in FIG. 10A wherein only one-quarter of the mirrors 53 are illuminated (two of the eight lights 54 turned on) and only one-quarter of the condenser aperture illuminated produces an extreme degree of parallax (the amount of image tilt or apparent specimen tilt) as illustrated in FIG. 4. The lighting arrangement in FIG. 10B with one-half of the mirrors 53 illuminated and thus one-half of the aperture illuminated produces a moderate degree of parallax angle or image tilt as illustrated in FIG. 3. The lighting arrangement in FIG. 10C with three-quarters of the mirrors illuminated produces a smaller degree of parallax angle as illustrated in FIG. 2. The simplicity with which the parallax angle of the image can be adjusted is a major improvement relative to the prior art, which requires the physical replacement of aperture masks in order to change the parallax angle. The present invention also provides a significant improvement over using an LCD shutter device, which is expensive and also results in loss of light and the unwanted polarization of the light beam.

Motion parallax 3D perception in an otherwise 2D microscope is made possible by the present invention without physical moving parts by the ability of the illuminator 51 to create dynamic shaped beams (beams that non-concentrically illuminate less than the entire area of the condenser aperture 42) that can be rotated about an axis 16 running through the center of the aperture and perpendicular thereto (see FIG. 5).

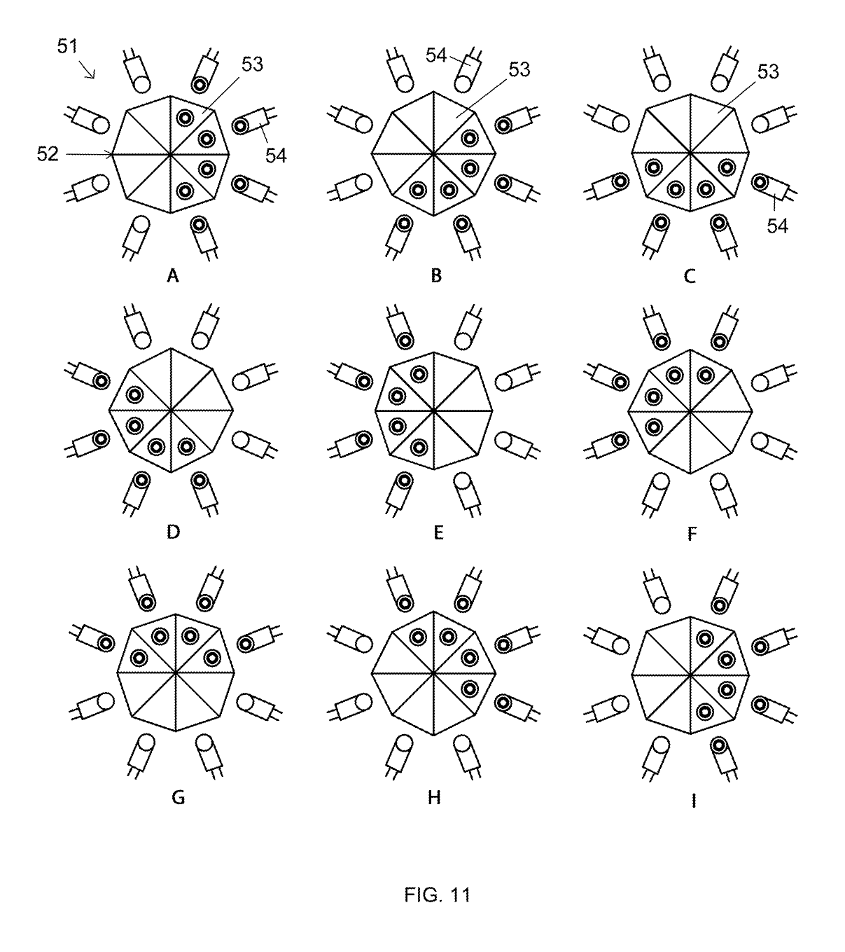

Referring to FIGS. 11A, a mirror 52 with eight facets 53 each having an adjacent light 54 is shown with a first set of four lights 54 turned on illuminating their adjacent facets. The other facets 53 are dark (their adjacent lights are off). FIG. 11B illustrates the same mirror 52 and lights 54, but with a second set of four lights 54 turned on. The second set of turned on lights 54 includes three of the same lights 54 as the first set and one not previously turned on whereby the second set is shifted by one facet in a clockwise direction. By sequentially and progressively turning off one light 54 and turning on another, a rotating dynamic shaped beam is created. Using the shifting pattern illustrated in FIGS. 11A-I, the specimen (not shown) is illuminated with oblique illumination which, when rotated, produces an image of the specimen that will be perceived as rotating in three-dimensional space, producing a motion 3D image of the specimen. FIGS. 11A-I illustrate one virtual rotation of a set of four lights 54 of a computer-controlled eight-light illuminator 51 which produces rotational 3D perception. A rotational speed of about one full rotation per second produces good quality 3D perception. Using more or less than four of eight lighting elements also produces 3D perception with different characteristics, such as with greater or less parallax angle, as illustrated in FIG. 10. Likewise, the total number of mirrors and lighting elements can be increased or decreased to produce varying effects.

FIGS. 12a-f illustrate the use of a lighting algorithm (executed by computer 62) similar to that described above with reference to FIGS. 11 A-I, but with an additional function to smooth out the rotational motion. FIG. 12a illustrates a set of four right-hand lighting elements 54 turned on at full output, producing a tilted view in the direction indicated by the arrow 61. Rather than simply sequencing directly to the configuration shown in FIG. 12c, which would clock the rotation forward (clockwise) by one-eighth of a rotation (as shown by the arrow 63), the algorithm executed by computer 62 causes an intermediate step wherein the next light 54 to be turned on is at a diminished level (indicated by a single circle) (e.g., 50% of full illumination), while, at the same time, the trailing light 54 to be extinguished is first reduced by some amount which, in a preferred embodiment, is the same amount as the leading light 54 is increased. In this way, before a second configuration of four lights 54 are all on at the same output intensity, five lights 54 are turned on, with the leading and trailing lights at some diminished output relative to the other lights 54. By interposing an intermediate step which phases in and out the light of the leading and trailing lights 54, the virtual rotation advances by one-sixteenth of a full rotation step (FIG. 12b), thereby smoothing the appearance of the rotational motion. In one embodiment of the invention, to even further smooth out the apparent rotation of the specimen (not shown), an algorithm is implemented by the computer by which during the intermediate step the leading light element 54 is phased from zero to full illumination over a specified period of time (full illumination being the lumen output of the lighting elements between the leading and trailing elements) and the trailing element from full to zero over the same period of time. Using this algorithm, even a six-element lighting system produces smooth specimen rotation.

Thus, as illustrated, one predetermined sequence in one configuration causes a first set of less than all of said light sources 54 to be turned on at a first output level for only a predetermined period of time after which a second set of light sources 54 is turned on for only a predetermined period of time wherein said second set of light sources includes one more light source than said first set of light sources and two of said second set light sources are at an output level below said first output level.

After the second set of light sources is turned on for a predetermined period of time, a third set of light sources is turned on for only a predetermined period of time wherein the third set of light sources 54 includes all but one light source 54 of the second set of light sources and all of the third set of light sources 54 are at the first output level.

The computer 62 (as shown in FIG. 8) that is connected to driver circuit 61 that is connected to the individual lighting elements 54 is programmed to produce the various patterns of “moving” light beams, including the ones discussed above.

It will be apparent to those skilled in the art, however, that many combinations of lighting patterns are possible in addition to those described herein for purposes of illustrating the invention's capabilities. The number of lights and facets, the timing of rotation and phasing in and out of leading and trailing lights provide a myriad of possible combinations by which the illuminator 51 of the present invention can be used to meet specific needs and produce high quality, real-time 3D perception without the need to wear special glasses in an otherwise 2D microscope.

FIG. 13 illustrates an example of a graphical user interface (GUI) that allows a user to easily set the computer to produce the desired illumination effect. By selecting “MONO”, all of the lighting elements are illuminated and the microscope functions as a standard 2D microscope. A stereo pair image is produced by taking a photograph after selecting the “LEFT” button and then taking a photograph after selecting the “RIGHT” button. Such a stereo pair image can easily be seen in 3D using any one of a number of existing 3D display systems. The “LIGHTING DIRECTION” is controlled by selecting “Top”, “Right”, “Left”, “Bottom”, or any angle from 0 to 360 degrees. The direction of lighting determines the direction of tilt of the specimen, as shown in FIGS. 1-4. The amount of “OBLIQUE LIGHTING” can be controlled by selecting “decrease” or “increase”, which will decrease or increase the apparent tilt of a specimen (FIG. 10).

By selecting “AUTO ROTATE 3D” on the user interface, each lighting element will be controlled so that, together, they appear to rotate automatically, similar to that shown in FIGS. 11 and 12. The speed of rotation is controlled by selecting the “up” and “down” arrows. One rotation per second is a comfortable speed to perceive the 3D images. By selecting and dragging the ball on the “MANUAL MOTION 3D” icon, both the angle and amount of tilted view can be controlled by the viewer at the same time.

Of course, various changes, modifications and alterations in the teachings of the present invention may be contemplated by those skilled in the art without departing from the intended spirit and scope thereof. As such, it is intended that the present invention only be limited by the terms of the appended claims.

1. An illuminator for a transmitted light microscope comprising:
a generally pyramid-shaped mirror having a plurality of facets; and
a light source disposed adjacent a plurality of said mirror facets.

2. The illuminator of claim 1 wherein said generally pyramid-shaped mirror has more than three mirror facets.

3. The illuminator of claim 2 wherein a said light source is disposed adjacent each of said mirror facets.

4. The illuminator of claim 3 wherein the number of said mirror facets is more than three and as many as sixteen.

5. The illuminator of claim 2 further comprising:
a power supply; and
an electronic circuit selectively connecting each said light source to said power supply whereby said light sources can be turned on and off individually.

6. The illuminator of claim 5 further comprising:
a computer operatively disposed with regard to said electronic circuit and programmed to cause said electronic circuit to turn said light sources on and off according to a predetermined sequence.

7. The illuminator of claim 6 wherein said light sources are light emitting diodes (LEDs).

8. The illuminator of claim 6 wherein:
said generally pyramid-shaped mirror has eight said mirror facets of equal size and shape; and
a said light source is disposed adjacent each said eight mirror facets.

9. The illuminator of claim 8 wherein said light sources are LEDs.

10. The illuminator of claim 6 wherein said predetermined sequence in one configuration first causes a first set of less than all of said light sources to be turned on while the remaining light sources are turned off and then causes a second set of the same number of light sources to be turned on while the remainder are off wherein each light source turned on in said second set is at positions 180 degrees from a light source turned on in said first set.

11. The illuminator of claim 10 wherein:
said generally pyramid-shaped mirror has eight said mirror facets of equal size and shape;
said light sources are light emitting diodes (LEDs);
a said LED is disposed adjacent each said eight mirror facets;
said first set of light sources includes six or less LEDs; and
said second set of light sources includes the same number of LEDs as said first set of light sources.

12. The illuminator of claim 5 whereby the intensity of said light sources when turned on can be varied.

13. The illuminator of claim 6 wherein:
said plurality of adjacent mirror facets are of the same shape and size;
said predetermined sequence in one configuration causes a first set of less than all of said light sources to be turned on for only a predetermined period of time after which a second set of light sources is turned on for only a predetermined period of time wherein said second set of light sources includes some of the same light sources in said first set of light sources and at least one light source not included in said first set of light sources.

14. The illuminator of claim 6 wherein:
said plurality of adjacent mirror facets are of the same shape and size;
said predetermined sequence in one configuration causes a first set of less than all of said light sources to be turned on at a first output level for only a predetermined period of time after which a second set of light sources is turned on for only a predetermined period of time wherein said second set of light sources includes said first set of light sources plus one more light source and two of said second set of light sources are at an output level below said first output level.

15. The illuminator of claim 14 wherein after said second set of light sources is turned on for a predetermined period of time after which a third set of light sources is turned on for only a predetermined period of time wherein said third set of light sources all of said light sources of said second set less one light source and all of said third set of said light sources are at said first output level.

16. The illuminator of claim 15 wherein two of said light sources of said second set of light sources have a continuously changing output level during the predetermined time that said second set of light sources is turned on.

17. An illuminator for a transmitted light microscope having a condenser aperture comprising:
a generally pyramid-shaped mirror having a plurality of facets disposed to be optically conjugate to the condenser aperture;
a light source disposed adjacent a plurality of said mirror facets wherein less than all of said light sources are turned on creating a non-concentric shaped beam at the condenser aperture.

18. The illuminator of claim 17 wherein said light sources are sequenced to rotate said non-concentric shaped beam creating a dynamic shaped beam at the condenser aperture.

19. A method for creating 3D perception in a 2D transmitted light microscope having a condenser aperture and a bulb illuminator the steps comprising:
replacing the bulb illuminator with an illuminator comprising a generally pyramid-shaped mirror having a plurality of facets and a light source disposed adjacent a plurality of said mirror facets;
turning some of the light sources on and some off in a sequence that creates a non-concentric shaped beam at the condenser aperture.

20. The method of claim 19 wherein the sequence creates a dynamic shaped beam at the condenser lens.
